(19) United States
(12) Patent Application Publication
(10) Pub. No.: US 2009/0154377 A1
(43) Pub. Date: Jun. 18, 2009

(54) Wireless Communication Apparatus

(76) Inventors: Shinichiro Tsuda, Kanagawa (JP); Masahisa Tamura, Kanagawa (JP); Kotaro Takagi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/960,435

(22) Filed: Dec. 19, 2007

(30) Foreign Application Priority Data
Dec. 22, 2006 (JP) P2006-346751

(51) Int. Cl. H04L 5/14

(52) U.S. Cl. 370/277

(57) ABSTRACT

A wireless communication apparatus includes an RF front-end unit constituting reception and transmission systems, a digital baseband signal processor, and a bias current circuit. The digital baseband signal processor performs a process of a digital baseband receive signal received from a reception system and performs a process of a digital baseband transmit signal supplied to a transmission system. The bias current circuit supplies a reference current to at least a part of a circuit constituting the reception system within the RF front-end unit. The bias current circuit switches the reference current supplied to at least the part of the circuit constituting the reception system within the RF front-end unit, in response to a transmission-operation control signal outputted by the digital baseband signal processor to the transmission system within the RF front-end unit.

### BACKGROUND OF THE INVENTION

1. Field of the Invention

The present invention relates to a wireless communication apparatus for performing communication between moving objects such as a mobile telephone and a wireless LAN. More particularly, it relates to a wireless communication apparatus in which a direct conversion system is applied for a frequency conversion of transmission and reception signals.

Still more particularly, the present invention relates to a wireless communication apparatus in which the direct conversion system is applied and which is used for a Duplex system in which transmission and reception operations are simultaneously performed. In particular, the present invention relates to a wireless communication apparatus in which a second-order distortion component caused by a leakage component of a transmission signal from a transmission system of its own station is inhibited and an inter-stage filter in a reception system is eliminated.

2. Description of Related Art

A mobile communication technology such as a mobile telephone, a wireless LAN (Local Area network) becomes widespread. In an RF (Radio Frequency) front-end of a mobile communication terminal, an analog baseband signal is up-converted to an RF band at the time of a transmission, and an RF reception signal is down-converted to the analog baseband signal at the time of a reception. A recent wireless communication device adopts a direct conversion system, as a frequency converter for up-converting or down-converting transmission and reception signals, in which a direct frequency conversion is performed using a carrier frequency f_{c} to a local frequency f_{LO}.

According to the direct conversion system, an external IF (Intermediate Frequency) filter (also referred to as an RF inter-stage filter) is not used. Therefore, the direct conversion system is suitable for miniaturization and integration, and does not principally generate a spurious frequency. Thus, the system excels in designing transmitting and receiving devices.

For example, in W-CDMA (Wideband Code Division Multiple Access), which is one of the wireless interface standards defined by international standard IMT-2000 (International Mobile Telecommunication 2000) of a third generation mobile communication, the direct conversion system is widely used.

The W-CDMA is a Duplex system in which transmission and reception are simultaneously performed by a frequency division. However, if the direct conversion system is applied to the W-CDMA, a received baseband signal is suffered by a second-order distortion component caused by a leakage component of a transmission signal of its own station at the time of making a call or in other cases. As a result, there is a concern about a problem in that degradation in sensitivity is caused.

In the W-CDMA, to avoid a near-far problem in which a transmission signal of low power reached from a far mobile station of a base station is buried in a transmission signal of high power reached from a near mobile station, a “power control” technology for adjusting a transmitting power from the mobile station and the base station is applied. As a result, a condition near a minimum receiving sensitivity is achieved on a reception side, and a maximum output transmission is performed on a transmission side. In this case, to prevent the above-described degradation in sensitivity in the reception system, there is a need of attenuating a leakage component of the transmission signal near a maximum-transmitting power time.

FIG. 8 shows a configuration example of a wireless communication apparatus of the direct conversion system applied to the Duplex system. As illustrated, to attenuate the leakage component of the transmission signal, it is general to use a BPF (inter-stage filter) for restricting a frequency band between stages of a low noise amplifier (LNA) and a quadrature demodulator in the reception system. This type of inter-stage filter is usually equipped externally to a circuit module constituting an RF front-end.

In a digital wireless communication, to realize a high-speed transmission, in which a frequency resource is flexibly managed under an environment where communication systems using the same waveband coexist, a spread spectrum (SS) system is positively introduced. That is, from the transmission side, a propagation signal of a digital format is spread in a frequency band wider than that of the original signal by a spread code, and in this state, the signal is transmitted. On the reception side, the same spread code is used to reverse-spread the received signal so that the original digital signal is decrypted.

Herein, along with a trend of a multi-band system, the above-described low noise amplifier and the inter-stage filter of the quadrature demodulator are required by each band to be used. Since the inter-stage filter is provided externally of an RF front-end circuit module, there is a concern about an increase in occupied space on a printed circuit board.

Therefore, there is a proposal for eliminating the inter-stage filer from a receiving unit of the direct conversion method, (for example, see M. Tamura et al., “A Fully Integrated Inter-Stage-Bandpass-Filter-Less Direct-Conversion Receiver for W-CDMA” (RF IC Symp. 2005 Digest)). If the inter-stage filter is rendered unnecessary, miniaturization and integration of a communication circuit are advanced. However, to eliminate the inter-stage filter in the reception system, it may be necessary to inhibit a leakage component of the transmission signal from a transmission system to improve IIP2 (Input 2nd order Intercept Point) and improve a phase noise component of a frequency hand equivalent to a transmission band of a received local signal. To realize such improvement, an increase in current consumption in the reception system is fundamentally accompanied, and thus, a new problem of less power consumption arises. To improve a second-order distortion resistance for the leakage component of the transmission signal from the transmission system, it may be mainly necessary to improve an IIP2 characteristic by the quadrature demodulator. Basically, the use of a differential circuit configuration may ideally cancel the second-order distortion component, and in reality, however, due to a relative deviation of elements such as a transistor, a resistance used in the circuit, a component which cannot be canceled results in the second-order distortion component, applying an interference to a desired wave component. Therefore, methods for improving the IIP2 may include an improvement of linearity itself and an improvement of a symmetric property of the differential circuit. Generally, the former intends to improve the IIP2 by increasing a bias current supplied to the transistor, and the latter intends to improve the same by using a large-sized transistor, resistance, or the like. Further, to sufficiently reduce the phase noise component of the frequency band that corresponds to a transmission band of the received local signal, it may be necessary to increase a reference current to a buffer of a local signal or a frequency divider. Herein, to reduce a noise component, it may be necessary to use a load of low resistance and increase a signal amplitude, and as a result, an increase in power consumption takes place.

On the other hand, in a stand-by time during which an intermittent reception is performed on a receiver side, the transmission system is not started. Thus, the IIP2 characteristic equivalent to that in a maximum transmission time and a phase noise characteristic of the received local signal may not necessarily be required. That is, the inventor et al., consider that in the stand-by time, for the purposes of improving the IIP2 characteristic and improving the phase noise component of the received local signal, it may not be necessary to increase the current consumption. In particular, this stand-by time is an important index for determining the capability of a mobile telephone, and various manufacturers for developing and manufacturing a mobile communication terminal are in the middle of a fierce competition in how a current consumption in the stand-by time can be reduced (for example, see Japanese Unexamined Patent Application Publication No. 8-18500, and Japanese Unexamined Patent Application Publication No. 2006-109183).

At the time of making a call where the transmission takes place, the maximum output power transmission frequency is low, and a level of an average transmission power is said to be lower by 5 to 10 dB than that of the maximum output. That is, the inventors of the present invention consider that, in most cases of transmission, the IIP2 characteristic equivalent to that in the maximum transmission time and the phase noise characteristic of the received local signal are not required, and there is a room for current reduction.

### SUMMARY OF THE INVENTION

The present invention addresses to provide an excellent wireless communication apparatus, to which a direct conversion system may be applied and may be used for a Duplex system in which transmission and reception operations are simultaneously performed.

It is desirable to provide an excellent wireless communication apparatus in which a second-order distortion component caused by a leakage component of a transmission signal from a transmission system of its own station is inhibited and an inter-stage filter in a reception system may be eliminated.

It also be desirable to provide an excellent wireless communication apparatus, capable of eliminating an inter-stage filter in a reception system, and suitably performing current reduction control of the reception system.

It is further desirable to provide an excellent wireless communication apparatus, capable of improving IIP2 characteristic and a phase noise characteristic of a received local signal to eliminate an inter-stage filter in a reception system, and inhibiting an increase in power consumption in a stand-by time during which no transmission is performed.

It is still further desirable to provide an excellent wireless communication apparatus, capable of reducing a current consumption, which intends to improve an IIP2 characteristic and a phase noise characteristic of a received local signal at the time of making a call during which a transmission is performed.

The present invention has been achieved in view of the above-described problems. In accordance with an embodiment of the present invention, there is provided a wireless communication apparatus capable of simultaneously performing transmission and reception operations, including an RF front-end processing unit, a digital baseband signal processor, and a bias current circuit. The RF front-end processing unit constitutes a reception system and a transmission system which shares an antenna via an antenna duplexer. The digital baseband signal processor performs a process of a digital baseband receive signal received from the reception system and performs a process of a digital baseband transmit signal supplied to the transmission system. The bias current circuit supplies a reference current to at least a part of a circuit constituting the reception system within the RF front-end processing unit. In response to a transmission-operation control signal outputted by the digital baseband signal processor to the transmission system within the RF front-end processing unit, the bias current circuit switches the reference current supplied to at least the part of the circuit constituting the reception system within the RF front-end processing unit.

It is a well-known problem that when a direct conversion system is used for a Duplex system in which transmission and reception are simultaneously performed, which is represented by W-CDMA, due to a transmission leakage wave caused as a result of a transmission wave of its own station circulating via the antenna duplexer to the reception system, a second-order distortion component is generated, which results in degradation in sensitivity. In the W-CDMA, a power control is performed to avoid a near-far problem, and thus, the transmission system transmits the maximum output power near the minimum reception sensitivity, and as a result, the degradation in sensitivity caused by the second-order distortion component becomes severer. Further, the transmission leakage wave causes the degradation in sensitivity also by a reciprocal mixing with a phase noise in a frequency band that corresponds to a transmission band of the received local signal.

That is, the reception system is required of a sufficient resistance, about a characteristic such as a second-order distortion, a phase noise, or the like, against a transmission leakage wave component at the time of transmitting the maximum output power. To improve an IIP2 characteristic, a layout excellent in symmetric property is designed, and at the same time, an approach that leads to a resultant increase in current consumption is adopted. Further, the improvement of the phase noise is also followed by the increase in current consumption. Thus a less power consumption of the reception system in the direct conversion system is an important challenge.

On the other hand, in a condition under which the transmission is not performed, no transmission leakage wave exists, and thus, the problem of the degradation in sensitivity by the reciprocal mixing accompanied by the above-described second-order distortion and the phase noise does not occur. That is, in the condition under which the transmission is not performed, a reception process may be performed without any problem in the reception system even when an amount of increase in current required for improving the IIP2 characteristic and improving the phase noise characteristic is reduced.

The wireless communication apparatus according to an embodiment of the present invention is configured such that the bias current circuit switches the reference current supplied to at least the part of the circuit constituting the reception system within the RF front-end processing unit in response to a transmission-operation control signal outputted by the digital baseband signal processor to the transmission system within the RF front-end processing unit.

That is, when the transmission-operation control signal outputted by the digital baseband signal processor is a signal instructing a transmission off (which means that the apparatus is in a stand-by state) to the transmission system within the RF front-end processing unit, the bias current circuit reduces the reference current supplied to at least the part of the circuit constituting the reception system within the RF front-end processing unit. Therefore, in a stand-by time during which the wireless communication apparatus performs an intermittent reception only, the current consumption of the reception system may be reduced.

Further, in the case where the digital baseband signal processor is provided with a configuration to output a transmission-power control signal for controlling a transmission power at the time of a transmission to the transmission system within the RF front-end processing unit, the bias current circuit, if the transmission-operation control signal is a signal instructing a transmission on to the transmission system within the RF front-end processing unit, that is, even in a period during which a transmission operation is performed, may reduce the reference current supplied to at least the part of the circuit constituting the reception system within the RF front-end processing unit, in response to the transmission-power control signal. Specifically, even at the time of making a call where the transmission is performed, the current consumption of the reception system may be reduced when the transmission power in the transmission system is not near the maximum transmission output level.

The wireless communication apparatus according to an embodiment of the present invention may further include second-order distortion characteristic detecting means for detecting a second-order distortion characteristic in the reception system of the RF front-end processing unit.

In such a case, notifying means may notify the bias current circuit of a detection result by the second-order distortion characteristic detecting means, and the bias current circuit may reduce the reference current supplied to at least the part of the circuit constituting the reception system within the RF front-end processing unit, in response to a notification from the notifying means.

Specifically, the second-order distortion characteristic detecting means detects whether the second-order distortion exceeds a predetermined level. When the transmission-operation control signal outputted by the digital baseband signal processor is a signal instructing a transmission on to the transmission system within the RF front-end processing unit and when a notification notifying that the second-order distortion exceeds the predetermined level is received, the bias current circuit renders variable the reference current supplied to at least the part of the circuit constituting the receiving system within the RF front-end processing unit.

Therefore, regarding a variation of the IIP2 characteristic of the reception system, it may be possible to attempt to improve the IIP2 characteristic by increasing a current at the time of making a call to only a reception system in which the IIP2 characteristic is not good, and thus, a yield may be improved, and at the same time, a low power consumption in a stand-by time may be implemented.

Further, the wireless communication apparatus includes a detection period during which the second-order distortion characteristic is detected by the second-order distortion characteristic detecting means at the time of inputting a power source of the wireless communication apparatus, and while the wireless communication apparatus is being inputted the power source, the notifying means may include holding means for holding a detection result of the second-order distortion characteristic by the second-order distortion characteristic detecting means in the detection period, and notify the bias current circuit of the held content. In such a case, even when there is a variation of the second-order distortion characteristic in each manufactured wireless communication apparatus, a calibration may be implemented at each time that the power source is inputted.

The bias current circuit renders variable the reference current corresponding not only to the detection result of the second-order distortion characteristic but also to the transmission-power control signal, and thus, when the transmission power in the transmission system at the time of making a call during which the transmission is performed is not near the maximum transmission output level, the current consumption of the reception system may be reduced.

According to an embodiment of the present invention, it may be possible to provide an excellent wireless communication apparatus to which a direct conversion system is applied, and which is used for a Duplex system in which transmission and reception operations are simultaneously performed.

Further, according to an embodiment of the present invention, it may be possible to provide an excellent wireless communication apparatus in which a second-order distortion component caused by a leakage component of a transmission signal from a transmission system of its own station is inhibited and an inter-stage filter in a reception system may be eliminated.

According to an embodiment of the present invention, it may be possible to provide an excellent wireless communication apparatus, capable of reducing an inter-stage filter in a reception system, and suitably performing current reduction control of the reception system.

According to an embodiment of the present invention, it may be possible to provide an excellent wireless communication apparatus, capable of improving an IIP2 characteristic and a phase noise characteristic of a received local signal to eliminate an inter-stage filter in a reception system, and inhibiting an increase in power consumption of the reception system in a stand-by time during which no transmission is performed.

Further, according to an embodiment of the present invention, when a transmission near the maximum transmission output level is not performed at the time of making a call during which the transmission is performed, it may be possible to provide an excellent wireless communication apparatus capable of reducing a current consumption, which intends to improve an IIP2 characteristic and a phase noise characteristic of a receive local signal.

According to an embodiment of the present invention, regarding a variation of an IIP2 characteristic of a reception system of the wireless communication apparatus, it may be possible to attempt to improve the IIP2 by increasing a current at the time of making a call to only a reception system in which the IIP2 characteristic is not good, and thus, a yield may be improved, and at the same time, a less power consumption in a stand-by time may be implemented. Further, it may be possible that just one second-order distortion characteristic test is sufficient.

Other aspects, features and advantages of the present invention will become apparent from the more detailed description based on embodiments of the present invention described later and the accompanying drawings.

### BRIEF DESCRIPTION OF THE DRAWINGS

FIG. 1 is a diagram showing a configuration of, mainly, an RF front-end unit of a wireless communication apparatus according to one embodiment of the present invention;

FIG. 2 is a diagram showing a configuration of, mainly, an RF front-end unit of a wireless communication apparatus according to another embodiment of the present invention;

FIG. 3 is a diagram showing a configuration of, mainly, an RF front-end unit of a wireless communication apparatus according to another embodiment of the present invention;

FIG. 4A is a graph for describing an operation of second-order distortion characteristic detecting means disposed in the wireless communication apparatus shown in FIG. 3;

FIG. 4B is a graph for describing an operation of the second-order distortion characteristic detecting means disposed in the wireless communication apparatus shown in FIG. 3;

FIG. 4C is a graph for describing an operation of the second-order distortion characteristic detecting means disposed in the wireless communication apparatus shown in FIG. 3;

FIG. 4D is a graph for describing an operation of the second-order distortion characteristic detecting means disposed in the wireless communication apparatus shown in FIG. 3;

FIG. 4E is a graph for describing an operation of the second-order distortion characteristic detecting means disposed in the wireless communication apparatus shown in FIG. 3;

FIG. 4F is a graph for describing an operation of the second-order distortion characteristic detecting means disposed in the wireless communication apparatus shown in FIG. 3;

FIG. 5 is a diagram showing a configuration of, mainly, an RF front-end unit of a wireless communication apparatus according to another embodiment of the present invention;

FIG. 6 is a diagram showing a configuration of, mainly, an RF front-end unit of a wireless communication apparatus according to another embodiment of the present invention;

FIG. 7 is a diagram showing a configuration of, mainly, an RF front-end unit of a wireless communication apparatus according to another embodiment of the present invention; and

FIG, 8 is a diagram showing a configuration example of a wireless communication apparatus applied to a Duplex system.

### DETAILED DESCRIPTION OF THE EMBODIMENTS

Hereinafter, embodiments of the present invention will be described in detail with reference to drawings.

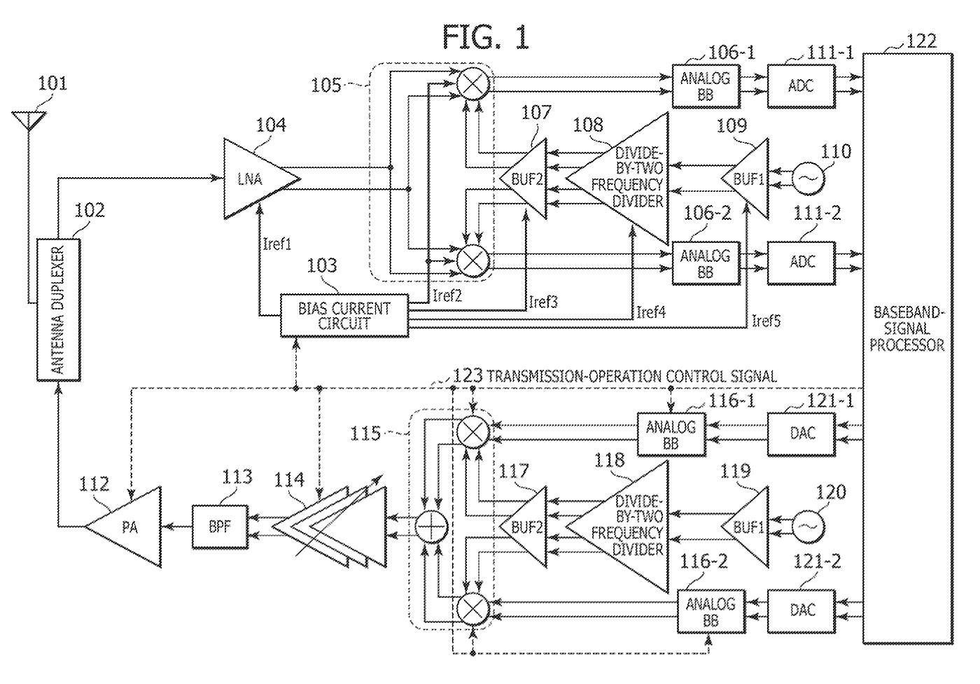

FIG. 1 is a diagram showing a configuration of, mainly, an RF front-end unit of a wireless communication apparatus according to one embodiment of the present invention. The wireless communication apparatus shown in the figure adopts a direct conversion system for a frequency conversion of transmission and reception signals, and is used for a Duplex system, and thus, it is possible to simultaneously perform transmission and reception operations.

A reception system of the wireless communication apparatus shown in the figure is provided with: a bias circuit 103; a low noise amplifier (LNA) 104 for amplifying an antenna receive signal; a quadrature demodulator circuit 105 for quadrature-modulating an analog RF signal by a direct conversion system; a receive analog baseband processor (analog BB) 106 and an A/D converter (ADC) 111 arranged in each I and Q channels down-converted by quadrature demodulation; a local oscillator 110; a first buffer circuit (BUF1) 109; a divide-by-two frequency divider 108; and a second buffer circuit (BUF2) 107. An A/D (analog-to-digital)-converted digital receive signal of each of I and Q channels is delivered to a digital baseband signal processor 122. It should be particularly noted that different from the RF front-end unit shown in FIG. 8, the reception system includes no inter-stage filter between the LNA 104 and the quadrature demodulator circuit 105.

A transmission system of the wireless communication apparatus shown in the figure is provided with: a D/A converter (DAC) 121 and a transmission analog baseband processor (analog BB) 116 arranged in each I and Q channels; a quadrature modulator circuit 115 for quadrature-modulating an analog baseband signal by the direct conversion system; a variable-gain amplifier circuit (VGA) 114 for amplifying the quadrature-modulated RF signal; an inter-stage BPF 113; a power amplifier (PA) 112 for point-force amplifying an RF transmission signal; a local oscillator 120; a first buffer circuit (BUF1) 119; a divide-by-two frequency divider 118; and a second buffer circuit (BUF2) 117, in which an RF process of the transmission signal delivered from the digital baseband signal processor 122 is performed. In a communication system such as W-CDMA, in which a transmission power control is required, the variable-gain amplifier circuit 114 needs to process a significant portion of a variable range of nearly 90 dB, and thus, in reality, is configured by a plurality of stages of VGA circuits connected in series.

The reception and transmission systems share an antenna 101 via an antenna duplexer (Duplexer) 102.

From the digital baseband signal processor 122 to the RF front-end unit, a transmission-operation control signal 123 is outputted. The transmission-operation control signal 123 is a binary signal formed of “H” and “L”, and when the signal is used, operations, that is, “transmission on” and “transmission off”, of the transmission system are controlled. In the embodiment, in response to output of the transmission-operation control signal 123, the bias current circuit 103 of the reception system switches a bias of a reference current supplied to each component constituting the reception system. It may be possible to supply the transmission-operation control signal 123, together with another control signal, via a 3-wire serial bus.

It is a well-known problem that when the direct conversion system is used for a Duplex system in which the transmission and reception are simultaneously performed, which is represented by W-CDMA, due to a transmission leakage wave caused as a result of a transmission wave of its own station circulating via the antenna duplexer to the reception system, a second-order distortion component is generated, which results in degradation in sensitivity. Herein, in the W-CDMA, a power control is performed to avoid a near-far problem, and thus, the transmission system transmits the maximum output power near the minimum reception sensitivity, and as a result, the degradation in sensitivity by the second-order distortion component becomes severer. Further, the transmission leakage wave causes the degradation in sensitivity also by a reciprocal mixing with a phase noise in a frequency band that corresponds to a transmission band of the received local signal.

That is, the reception system is required of a sufficient resistance, regarding a characteristic such as a second-order distortion, a phase noise, or the like, against a transmission leakage wave component at the time of transmitting the maximum output power. To improve an IIP2 characteristic, a layout excellent in symmetric property is designed, and at the same time, an approach that leads to a resultant increase in current consumption is adopted. Further, an improvement of the phase noise is also followed by the increase in current consumption, and thus, a less power consumption of the reception system in the direct conversion system is an important challenge.

On the other hand, in a condition under which the transmission is not performed, no transmission leakage wave exists, and thus, the problem of degradation in sensitivity by the reciprocal mixing accompanied by the above-described second-order distortion and the phase noise does not occur. That is, in the condition under which no transmission is performed, even when an amount of increase in current required for improving the IIP2 characteristic and improving the phase noise characteristic is reduced, the reception process may be performed without any problem in the reception system.

Specifically, in the configuration of the wireless communication apparatus shown in FIG. 1, when the transmission operation control signal is “L”, that is, a signal instructing “transmission off”, reference currents Iref1 to Iref5 to all circuit blocks generated in the bias circuit 103 of the reception system, or only a reference current of at least a part of the circuit block is reduced, and as a result, it may be possible to reduce the current consumption of the reception system in a stand-by time.

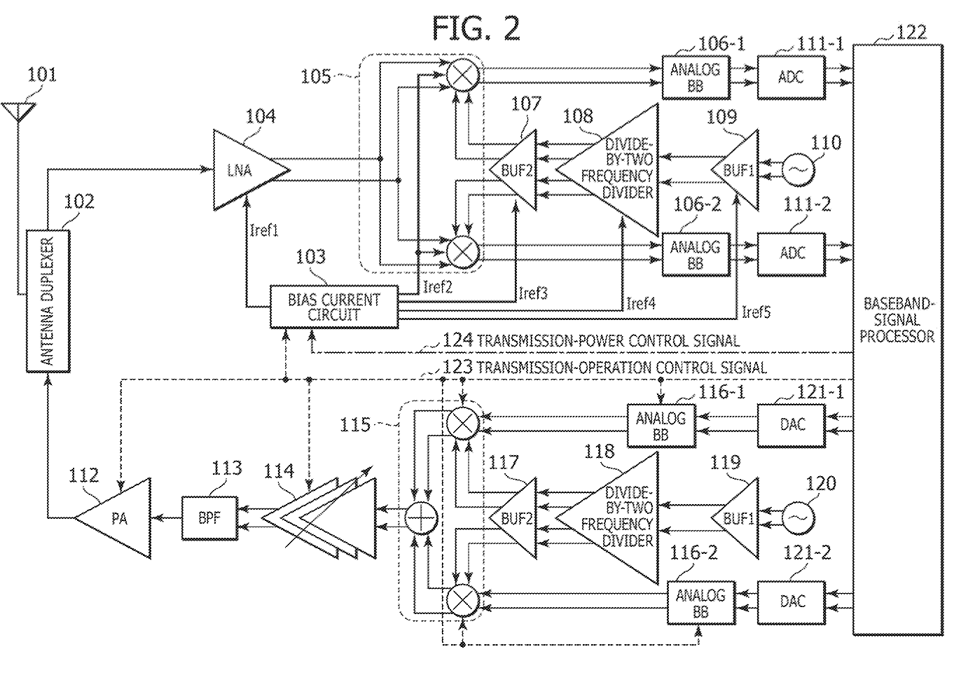

FIG. 2 is a diagram showing a configuration of, mainly, an RF front-end unit of a wireless communication apparatus according to another embodiment of the present invention. The wireless communication apparatus shown in the figure differs from the wireless communication apparatus shown in FIG. 1 in that it is configured such that the digital baseband signal processor 122 outputs a transmission-power control signal 124 prepared as a signal for controlling a gain of the transmission system, accompanied by the power control, and the bias circuit 103 of the reception system is capable of rendering variable a reference current generated by using not only the transmission-operation control signal 123 but also the transmission-power control signal 124.

On a condition under which the transmission-power control signal 124 does not instruct a transmission near the maximum output power, it may be possible to reduce at least a part of the reference current generated by the bias circuit 103 of the reception system even when the transmission-operation control signal 123 is “H”, that is, a signal instructing the “transmission on”. As a result of this, it may be possible to reduce the current consumption of the reception system at the time of making a call. However, when the current of the reception system is rendered variable by the transmission output power level at the time of making a call, it is desirable to design such that the current is rendered variable in such a range that the gain of the reception system have nearly no influence.

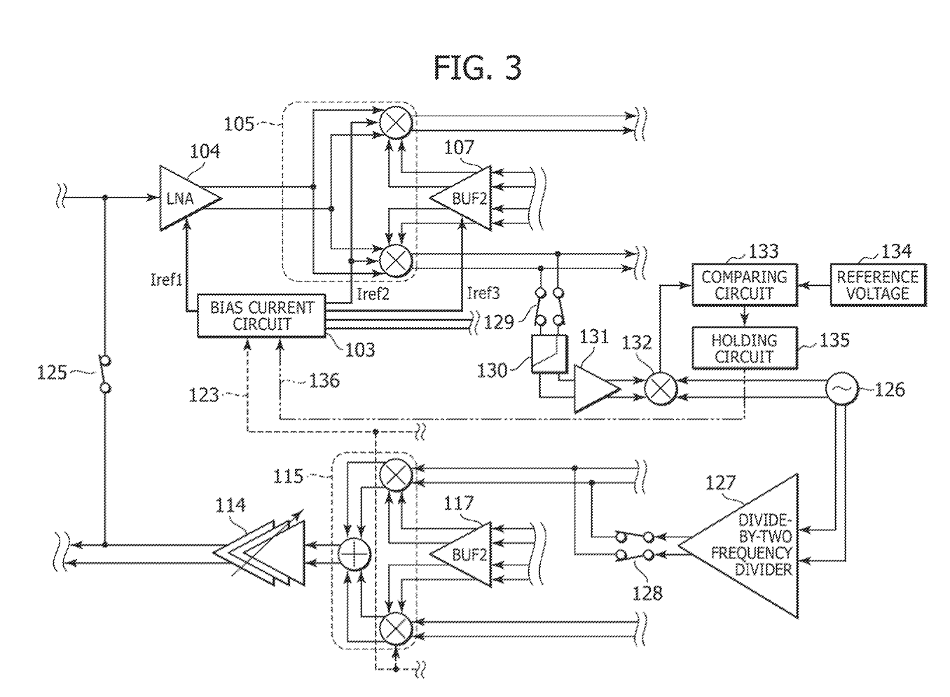

FIG. 3 is a diagram showing a configuration of, mainly, an RF front-end unit of a wireless communication apparatus according to another embodiment of the present invention. The wireless communication apparatus shown in the figure differs from the wireless communication apparatus shown in FIG. 1 mainly in that it mounts means for detecting a second-order distortion characteristic.

The second-order distortion characteristic detecting means shown in the figure is provided with: an oscillation circuit 126 for outputting a test-use signal having a predetermined frequency; a divide-by-two frequency divider 127 for dividing the test-use signal by two; a switch 128 for inputting a frequency signal divided by two into a quadrature modulator 115; a switch 125 for supplying a quadrature-modulated test signal to the reception system; a switch 129 for inputting a demodulated signal by the quadrature demodulator 105 into second-order distortion detecting means in the reception system; an LPF 130 for performing band limitation of the demodulated signal and a differential amplifier circuit 131 for a differential amplification; a down-converter 132 which uses the frequency signal outputted by the oscillation circuit 126 to down-convert the demodulated signal, thereby converting it into a DC voltage; and a comparing circuit 133 for comparing the DC voltage with a predetermined reference voltage 134, in which a frequency f_{TEST} which is the test signal outputted by the oscillation circuit 126 is mounted on the transmission system and supplied to the reception system so that the second-order distortion characteristic is detected. A holding circuit 135 holds a comparison result in the comparing circuit 133, and outputs a comparison determining signal 136 to the bias current circuit 103.

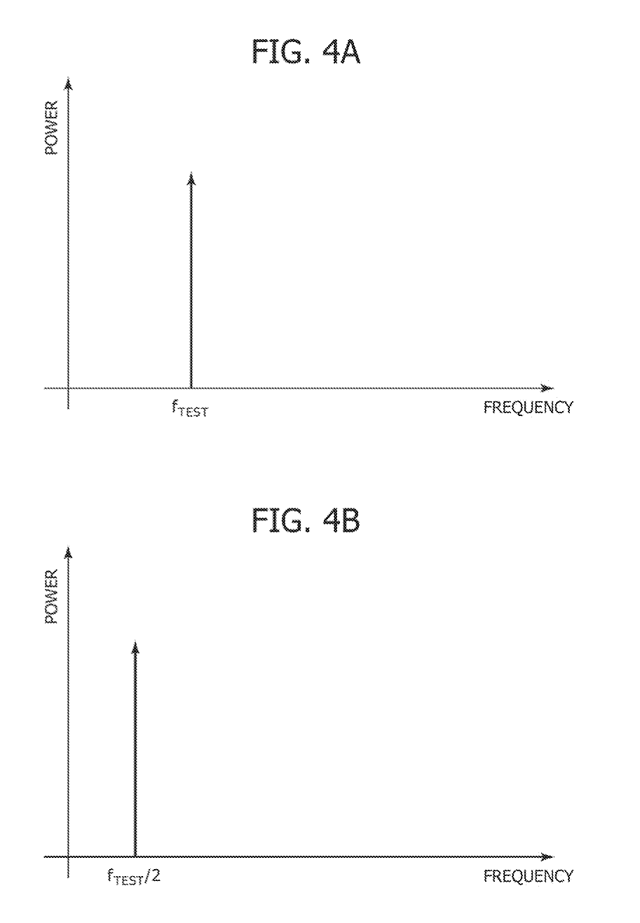

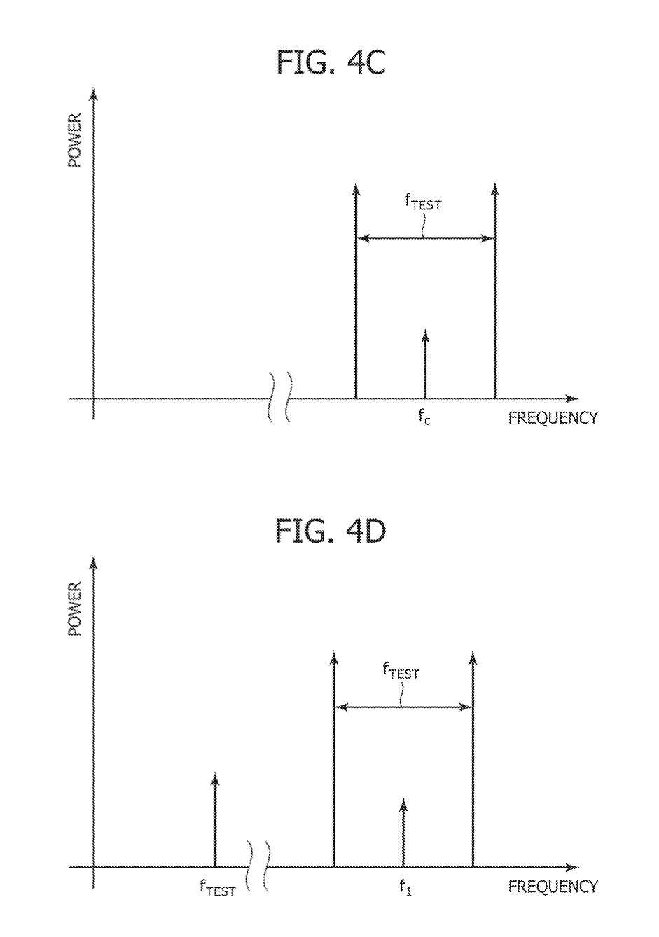

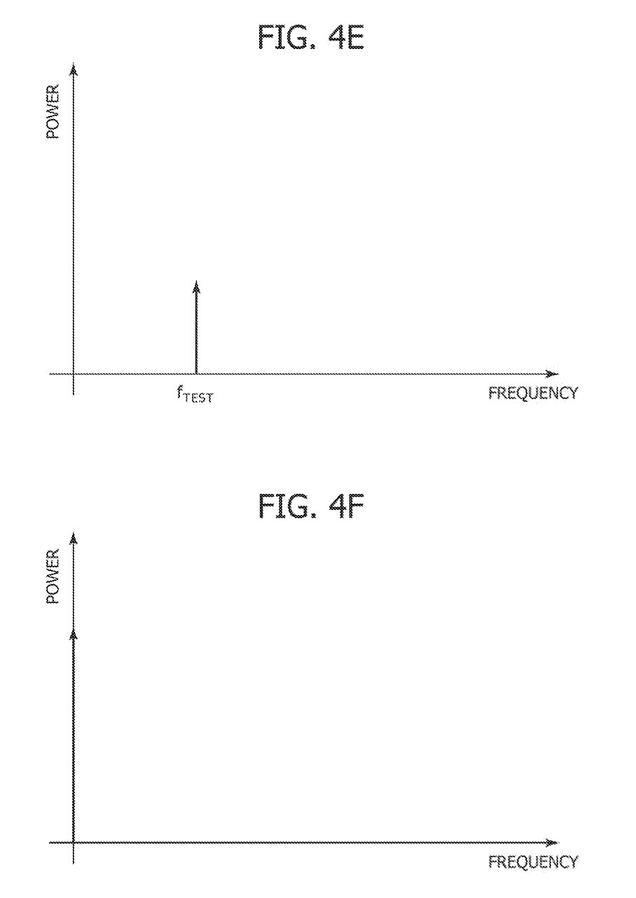

FIG. 4A to FIG. 4F show states in which the test-use signal is processed at each stage. The oscillation circuit 126, firstly, oscillates the frequency f_{TEST} of about 2 MHz, for example, and outputs this frequency as the test-use signal (see FIG. 4A). A frequency f_{TEST}/2 obtained by dividing the test-use signal f_{TEST} by two (see FIG. 4B) is applied via the switch 128 to an input of the quadrature modulator 115 of either one of the I or Q pass of the transmission system. The switch 128 turns on only in a test period provided immediately after a power source is inputted, for example, and turns off in other periods.

Subsequently, the f_{TEST}/2 is up-converted by a transmission carrier frequency f_{c} in the quadrature modulator 115 to become a double side-band signal of ±f_{TEST}/2 detuned relative to the transmission carrier frequency (see FIG. 4C). The two waves, as an RF signal for a test, are supplied via the switch 125 to an input of the LNA 104 of the reception system. The switch 125 turned on in the test period only, and turns off in other periods. For example, in Band I of W-CDMA, the transmission carrier frequency f_{c} is 1920 MHz to 1989 MHz.

The test-use RF signal is amplified in the LNA 104, and thereafter, quadrature-demodulated by the quadrature demodulator 105 by a receive carrier frequency. A fundamental wave of output of the quadrature demodulator is 190 MHz±f_{TEST}/2 when Band I of 3GPP (3rd Generation Partnership Project) standard is taken as an example. The second-order distortion component generated in the quadrature demodulator is f_{TEST} (see FIG. 4D. In the figure, f₁ is a frequency component of a difference of the carrier frequencies between the transmission and reception. For example, in the Band I of W-CDMA, it is 190 MHz).

In this situation, when the fundamental wave of 190 MHz±f_{TEST}/2 by using the low-pass filter 130 is attenuated via the switch 129, it may become possible to detect only a second-order distortion component f_{TEST} in output of the low-pass filter 130 (see FIG. 4E). Herein, the switch 129 is turned on in the test period only, and turns off in other periods.

The detected second-order distortion component f_{TEST} is amplified in the differential amplifier circuit 131, and thereafter, down-converted by the down-converter 132 using an oscillation frequency f_{TEST} of the oscillation circuit 126, and converted into a DC voltage (see FIG. 4F).

Further, a DC voltage value detected at the time of a desired IIP2 characteristic, which is an arbitrary threshold value, is set to the reference voltage 134, and by using the comparing circuit 133, the detected DC voltage is compared. When a DC voltage higher than the reference voltage is detected, a signal having a polarity of “H”, for example, is held, as a comparison determining signal 135, in the holding circuit 135. It is noted that the held information is held in a period during which the power source of the wireless communication apparatus is turned on. For example, the holding circuit 135 is configured by a volatile memory.

The information held in the holding circuit 135 is supplied, as the comparison determining signal 136, to the bias circuit 103 of the reception system. When the transmission operation signal 123 from the digital baseband signal processor is a signal instructing “transmission on” and the comparison determining signal 136 is “H”, the bias circuit 103 performs a task for switching to a bias current that may improve the IIP2. Thereby, only when there is a need of inhibiting the second-order distortion, the reference current to each component of the reception system is increased, and when there is no need, the reference current is reduced. Therefore, it may be possible to perform the improvement of the IIP2 characteristic of the reception system at the time of making a call, without increasing the current consumption of the reception system in the stand-by time.

It is needless to say that the above-described measurement method of the second-order distortion component is one example, and can be modified without departing from a sprit. The configuration of the second-order distortion characteristic detecting means is not limited to that shown in FIG. 3, and can be appropriately modified as long as a mechanism for notifying the bias current circuit 103 of a result of the second-order distortion detection is provided.

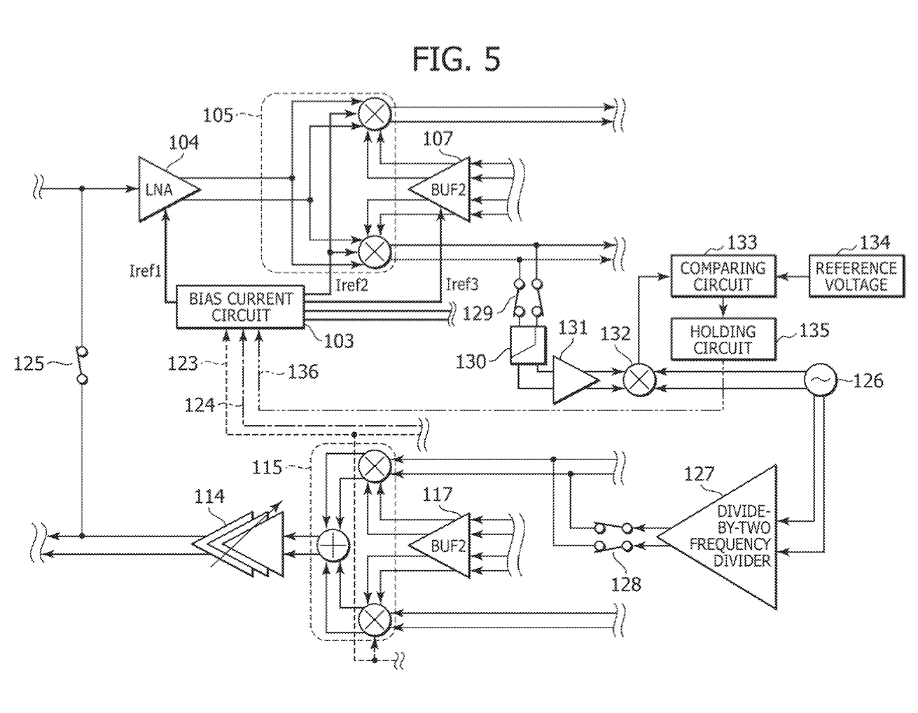

FIG. 5 shows a configuration of, mainly, an RF front-end unit of a wireless communication apparatus according to another embodiment of the present invention. The wireless communication apparatus shown in the figure is configured such that means for detecting a second-order distortion characteristic is mounted in the wireless communication apparatus shown in FIG. 2. According to such a configuration, it may be possible to improve the IIP2 characteristic by using not only the transmission-operation control signal 123 but also the transmission-power control signal 124 prepared as a signal for controlling a gain of the transmission system, accompanied by the transmission power control. Therefore, on a condition under which the maximum output power is not transmitted even at the time of making a call, an increase in current consumption required for improving the IIP2 characteristic of the reception system is omitted, and to thereby reduce the power consumption of the reception system even at the time of the transmission.

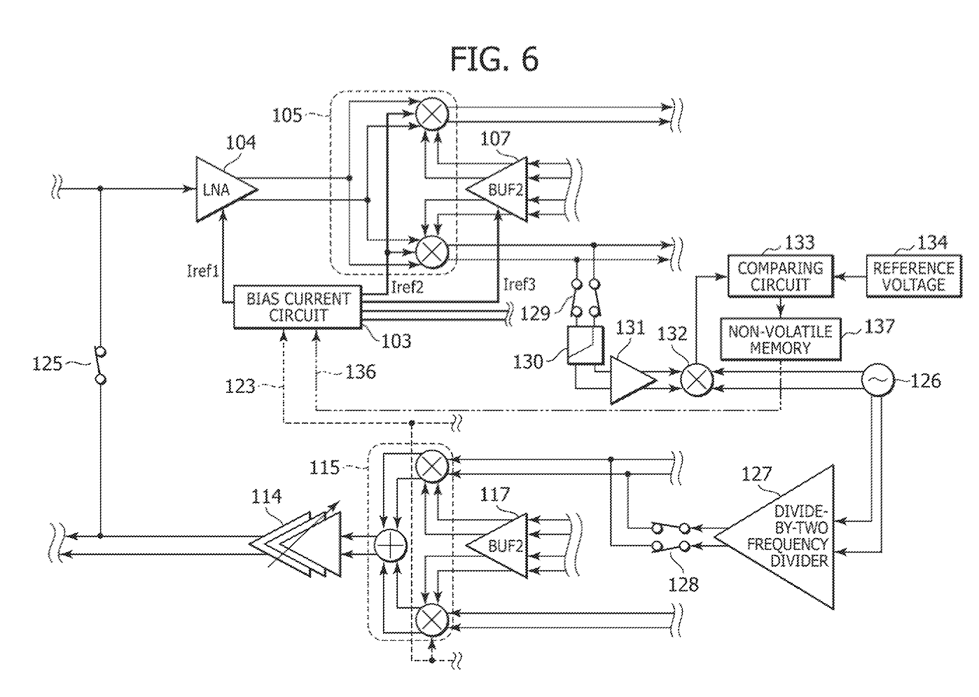

FIG. 6 shows a configuration of, mainly, an RF front-end unit of a wireless communication apparatus according to another embodiment of the present invention. The wireless communication apparatus shown in the figure uses a non-volatile memory 137, as a holding circuit for holding a detection result of the second-order distortion characteristic in the wireless communication apparatus shown in FIG. 3. Accordingly, a current at the time of making a call is increased in only a reception system in which the IIP2 characteristic is not good to improve the IIP2 characteristic, and thus, it may become possible to reduce the current consumption of the reception system in the stand-by time. The detection result of the second-order distortion characteristic is stored in the non-volatile memory 137, and thus, just one measurement of the IIP2 characteristic of the reception system is sufficient.

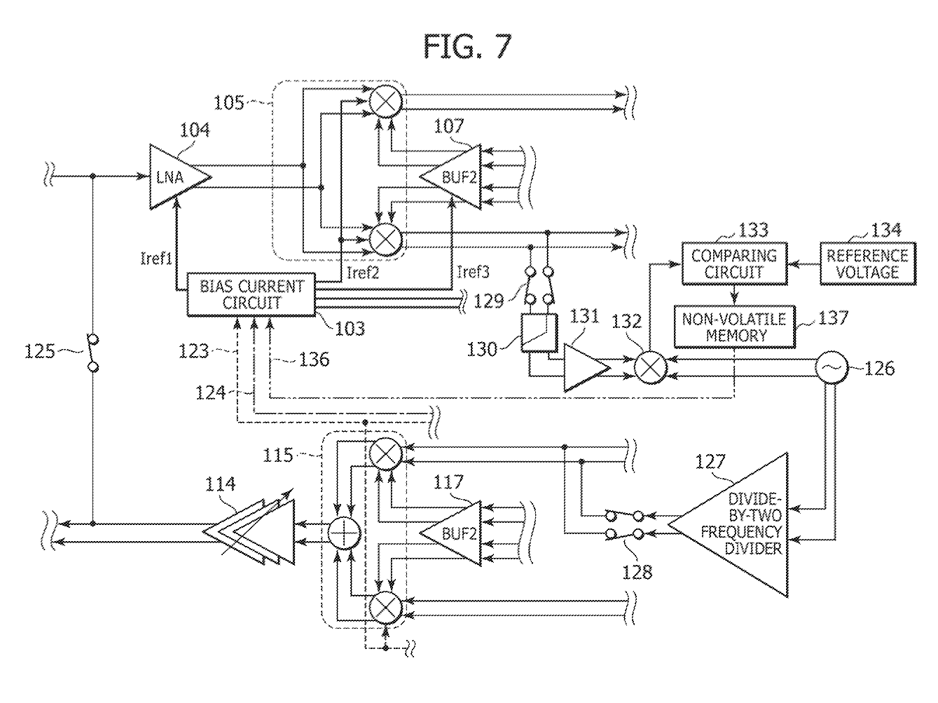

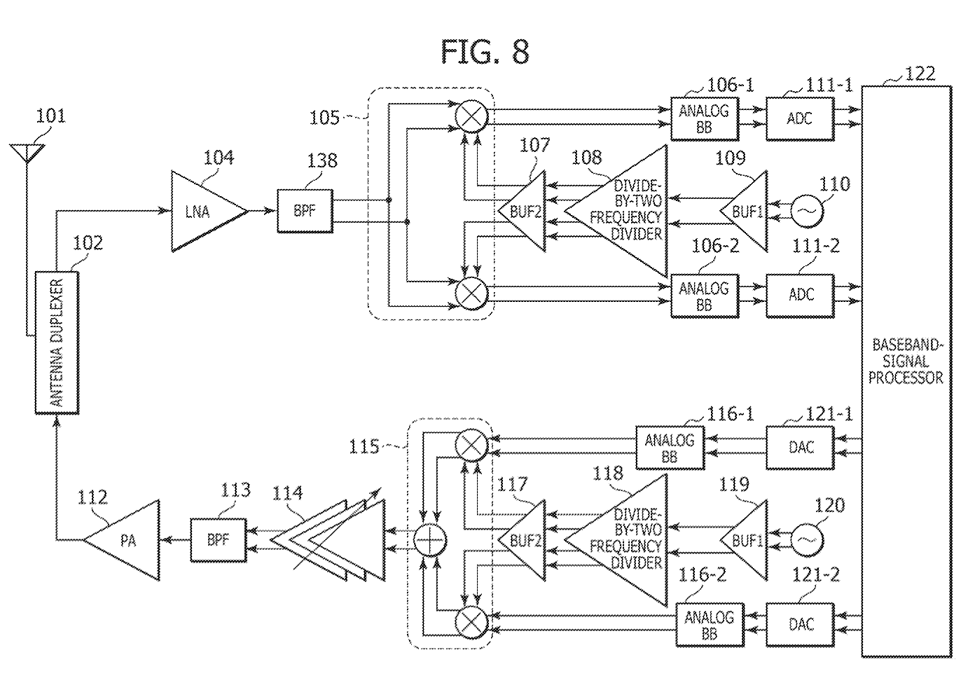

FIG. 7 shows a configuration of, mainly, an RF front-end unit of a wireless communication apparatus according to another embodiment of the present invention. The wireless communication apparatus shown in the figure uses the non-volatile memory 137, as a holding circuit for holding a detection result of the second-order distortion characteristic in the wireless communication apparatus shown in FIG. 5. Therefore, just one measurement of the IIP2 characteristic of the reception system becomes sufficient (the same as above).

As described above, with reference to the specific embodiments, the present invention is described in detail. However, it is obvious that a person skilled in the art can realize amendment or replacement of the embodiments without departing from a sprit of the present invention.

In the specification, the description is mainly given of the embodiments applied to the W-CDMA but a sprit of the present invention is not limited thereto. The present invention may be similarly applied to a wireless communication apparatus in which the direct conversion system is applied and which is used for the Duplex system; that in which the direct conversion system is not adopted; or that used for various communication systems in which the transmission and reception operations are not simultaneously performed.

In summary, the present invention is disclosed as an illustrative mode, and a content of a description of the specification should not be interpreted restrictively. To determine the sprit of the present invention, the claims should be taken into consideration.

The present application claims benefit of priority of Japanese patent Application No. 2006-346751 filed in the Japanese Patent Office on Dec. 22, 2006, the entire contents of which are incorporated herein by reference.

What is claimed is:

1. A wireless communication apparatus capable of simultaneously performing transmission and reception operations, comprising:
an RF front-end unit constituting a reception system and a transmission system, the reception system and the transmission system sharing an antenna via an antenna duplexer;
a digital baseband signal processor configured to perform a process of a digital baseband receive signal received from the reception system and performing a process of a digital baseband transmit signal supplied to the transmission system; and
a bias current circuit configured to supply a reference current to at least a part of a circuit constituting the reception system within the RF front-end unit,
wherein the bias current circuit switches the reference current supplied to at least the part of the circuit constituting the reception system within the RF front-end unit, in response to a transmission-operation control signal outputted by the digital baseband signal processor to the transmission system within the RF front-end unit.

2. The wireless communication apparatus according to claim 1, wherein the bias current circuit reduces the reference current supplied to at least the part of the circuit constituting the reception system within the RF front-end unit when the transmission-operation control signal outputted by the digital baseband signal processor is a signal instructing a transmission off to the transmission system within the RF front-end unit.

3. The wireless communication apparatus according to claim 1, wherein:
the digital baseband signal processor outputs a transmission-power control signal for controlling a transmission power at a time of a transmission to the transmission system within the RF front-end unit, and
when the transmission-operation control signal outputted by the digital baseband signal processor is a signal instructing a transmission on to the transmission system within the RF front-end unit, the bias current circuit renders variable the reference current supplied to at least the part of the circuit constituting the reception system within the RF front-end unit, in response to the transmission-power control signal.

4. The wireless communication apparatus according to claim 1, further comprising:
second-order distortion characteristic detecting means for detecting a second-order distortion characteristic in the reception system of the RF front-end unit; and
notifying means for notifying the bias current circuit of a detection result by the second-order distortion characteristic detecting means,
wherein the bias current circuit renders variable the reference current supplied to at least the part of the circuit constituting the reception system within the RF front-end unit, in response to a notification from the notifying means.

5. The wireless communication apparatus according to claim 4, wherein:
the second-order distortion characteristic detecting means detects whether a second-order distortion exceeds a predetermined level, and
when the transmission-operation control signal outputted by the digital baseband signal processor is a signal instructing a transmission on to the transmission system within the RF front-end unit, and when a notification notifying that the second-order distortion exceeds a predetermined level is received, the bias circuit renders variable the reference current supplied to at least the part of the circuit constituting the reception system within the RF front-end unit.

6. The wireless communication apparatus according to claim 4, wherein:
the second-order distortion characteristic detecting means detects a detection period during, and
the notifying means includes holding means configured to hold a detection result of the second-order distortion characteristic by the second-order distortion characteristic detecting means in the detection period, and notifies the bias current circuit of the held content.
The wireless communication apparatus according to claim 4, wherein:
the digital baseband signal processor outputs to the transmission system within the RF front-end unit a transmission-power control signal for controlling a transmission power at a time of a transmission, and
when the transmission-operation control signal outputted by the digital baseband signal processor is a signal instructing a transmission on to the transmission system within the RF front-end unit, the bias current circuit renders variable the reference current supplied to at least the part of the circuit constituting the reception system within the RF front-end unit, in response to a notification from the notifying means and the transmission-power control signal.

8. The wireless communication apparatus according to claim 6, wherein:
the detection period is provided at a time of inputting a power source of the wireless communication apparatus, and
the notifying means holds the detection result of the second-order distortion characteristic in the holding means formed of a volatile memory while the power source to the wireless communication apparatus is being inputted, or updates a content of the holding means formed of the non-volatile memory at every time that the second-order distortion characteristic is detected at a time of inputting the power source.

9. The wireless communication apparatus according to claim 6, wherein:
the detection period is arbitrarily provided, and
the notifying means holds the detection result of the second-order distortion characteristic in the holding means formed of a non-volatile memory.
